(19) United States
(12) Patent Application Publication
(10) Pub. No.: US 2005/0045728 A1
(43) Pub. Date: Mar. 3, 2005

(54) Enhanced method and apparatus for capturing and processing coupon redemption data

(76) Inventor: James B. Kargman, Chicago, IL (US)

Correspondence Address: GREENBERG TRAURIG, LLP, 77 WEST WACKER DRIVE, SUITE 2500, CHICAGO, IL, 60601-1732, US

(21) Appl. No.: 10/884,213

(22) Filed: Jul. 2, 2004

Related U.S. Application Data
(60) Provisional application No. 60/484,978, filed on Jul. 3, 2003.

(51) Int. Cl. G06K 7/10; G06K 9/22

(52) U.S. Cl. 235/462.45

(57) ABSTRACT

A method and an apparatus is disclosed for redeeming coupons having encoded information such as bar codes, and for capturing coupon redemption data. A scanner, such as a hand-held bar code scanner, captures the coupon's encoded information, together with timestamp information identifying when the coupon was redeemed. This information is first transferred to a local processor. The local processor automatically uploads the coupon redemption data in real-time to a central coupon database management system, via a data communication link, such as the Internet. The central coupon database management system gathers statistical information among a plurality of redeemed coupons, and is capable of analyzing the statistical information for patterns in redemption frequencies, relative to a plurality of media outlets by which associated coupons were distributed to consumers.

This application claims priority under 35 U.S.C. 119(e) of the filing date of U.S. Ser. No. 60/484,978.

### BACKGROUND OF THE INVENTION

1. Field of the Invention

The present invention relates in general to coupons and, more particularly, to systems for the automated capturing and processing of coupon redemption information.

2. Background and the Prior Art

Coupons are a well known device used in many different areas of commerce towards promoting the sale of goods and/or services and otherwise attracting consumer interest in new or existing products or services. Coupons are indeed commonly used by retail outlets selling hard goods originating from many different manufacturers, as well as by restaurants offering a more limited number of food items on a dine-in and delivery basis.

Following their presentment and use by a customer, coupons are typically retained by the retail outlet, collected and consolidated towards being ultimately passed back to a central coupon processing facility. At that facility, verification, validation and other such redemption activities are performed. Moreover, at that facility, the coupons may further be analyzed toward determining, statistically, where and when particular types of coupons were most frequently presented by consumers. The generation of redemption data, and in particular, the providing of that data to the manufacturer, is something that typically takes a considerable amount of time. Indeed, it is not unusual for such data to take four weeks before being returned.

Accordingly, it is an object of the present invention to provide a highly automated coupon redemption data processing system.

It is another object of the present invention to provide an automated coupon redemption data processing system that provides coupon redemption data to a retail outlet, a franchisor, a manufacturer or vendor in real-time.

It is yet another object of the present invention to provide a central coupon database management system capable of gathering statistical information across a plurality of redeemed coupons.

It is still another object of the present invention to provide a central coupon database management system capable of automatically generating additional coupons based upon an analysis of statistical information gathered across a plurality of redeemed coupons.

These and other desirous characteristics of the present invention will become apparent in light of the present specification, claims and drawing.

### SUMMARY OF THE INVENTION

A method for redeeming coupons having encoded information printed thereon and for processing coupon redemption data is disclosed where a preferred embodiment of the invention comprises the steps of: scanning a coupon to capture encoded information; recording timestamp information in association with the encoded information where the timestamp information specifying the date and approximate time when the coupon was scanned; transferring the encoded information and the associated timestamp information to a local processor; and automatically uploading the encoded information and the associated timestamp information from the local processor to a central coupon database management system in real-time via a data communication link. The present invention further includes the step of gathering coupon redemption statistical information from among a plurality of redeemed coupons as well as the step of analyzing the coupon redemption statistical information toward identifying patterns in redemption frequencies, in association with a plurality of media outlets by which associated coupons were distributed to consumers. According to the present invention additional coupons may be dynamically generated based upon the analyzed coupon redemption statistical information and accordingly targeted to one or more of the plurality of media outlets. It is contemplated that at least one of the plurality of media outlets may comprise a printed newspaper. In addition, the invention may include the step of analyzing the coupon redemption statistical information to determine an overall effectiveness of a marketing campaign by which the coupons are distributed to consumers.

In a preferred embodiment, the encoded information of the coupon comprises bar coded information printed or displayed upon a coupon, and the step of scanning a coupon's encoded information comprises scanning the coupon's bar coded information using a bar code scanner, such as a hand-held bar code scanner. The hand-held scanner may additionally comprise a portable hand-held bar code scanner. As disclosed, the local processor includes a local data link for accepting data from the bar code scanner and wherein the local data link comprises a scanner cradle operably coupled to the local processor. The step of transferring the encoded information and associated timestamp information comprises placing the scanner into the scanner cradle to automatically transfer the encoded information and associated timestamp information.

The local data link may comprise a wireless data link, and accordingly the step of transferring the encoded information and associated timestamp information comprises placing the scanner in sufficient proximity to the local processor to establish a reliable wireless data connection therebetween to automatically transfer the encoded information and associated timestamp information. The data link may comprise an internet connection operably coupling the local processor and the central coupon database management system or alternatively may comprise modem and conventional voice telephone connection.

In one embodiment of the present invention a point-of-sale system is operably coupled to the local processor.

Viewed as an apparatus the present coupon redemption and processing system for use in association with coupons having encoded information, comprises: a scanner capable of scanning the coupon's encoded information and recording timestamp information relative to when the coupon was scanned; a local processor having a local data link connectable to the scanner and capable of accepting and temporarily storing the coupon's encoded information and associated timestamp information when a local data connection is established between the local processor and the scanner; a central coupon database management system, remotely located relative to the local processor and capable of gathering statistical information from among a plurality of redeemed coupons; and a data communication link operably coupled to the local processor and the central coupon database management system for transferring the coupon's encoded information and associated timestamp information in real-time from the local processor to the central computer database management system.

### BRIEF DESCRIPTION OF THE DRAWING

FIG. 1 is a block diagram of a coupon redemption data processing system, according to the present invention.

### DETAILED DESCRIPTION OF THE INVENTION

While this invention is susceptible of embodiment in many different forms, there are shown in the drawing and will be described in detail, several specific embodiments, with the understanding that the present disclosure is to be considered as an exemplification of the principles of the present invention and is not intended to limit the invention to the embodiments illustrated.

The present invention relates to a method and apparatus for processing coupons, and in particular to a method and apparatus by which critical information relative to the redemption of coupons can be captured at the point-of-sale and processed and provided to vendors in real time to permit the substantially immediate dynamic regeneration of additional coupons and/or promotional offers.

Indeed, coupons are a mechanism commonly used by pizza restaurants to drive business and otherwise entice new and existing customers to purchase food items. A pizza restaurant coupon typically comprises a printed piece of paper which may be disseminated in print media, such as a newspaper or magazine, as a hand-out, and/or as a direct mail piece which may be mailed to a consumer's home or office address. The consumer simply takes the coupon to the pizza restaurant and at the time an order is placed are able to take advantage of the promotional offer set forth on the coupon. Coupons may offer the consumer a fixed discount, such as a 10% discount, or 2-for-1, or buy one-get one free promotional offer.

It is common for coupons to include a bar coded field which encapsulates encoded data which identifies various data points. Such bar coded data typically comprises the UPC code which when scanned by a bar code scanner may identify the coupon with the item being purchased. The barcode is typically scanned by the sales clerk passing it over a laser-driven barcode reader, which in turn, informs the point-of-sale system that the consumer is redeeming a coupon. This action causes the point-of-sale system to verify that indeed, a qualifying purchase has been made and to apply the appropriate discount represented by the coupon.

The present invention is designed to provide redemption data to a retail outlet, a manufacturer or vendor in real-time. In the context of a franchised pizza restaurant chain, the data can be provided to the franchiser in real-time.

Using this real-time redemption data and an associated computerized coupon database management system, the outlet/vendor is able to dynamically generate new coupons based upon the redemption statistics, thus targeting marketing efforts and otherwise enhancing the promotion of the vendor's goods or services.

The present invention is particularly designed to be usable by a store/retail outlet offering goods and/or services which does not otherwise possess a sophisticated and expensive point-of-sale computerized system with integrated bar code scanning capabilities, as typically found in a grocery store environment. For example, a typical fast food outlet such as a pizza restaurant does not utilize barcode technology inasmuch as it is not necessary to their business. A limited menu with a limited number of items permits the use of dedicated order entry terminals and/or “cash registers” specifically tailored to that business. For such businesses, the investment in barcode technology is often deemed to be otherwise unnecessary.

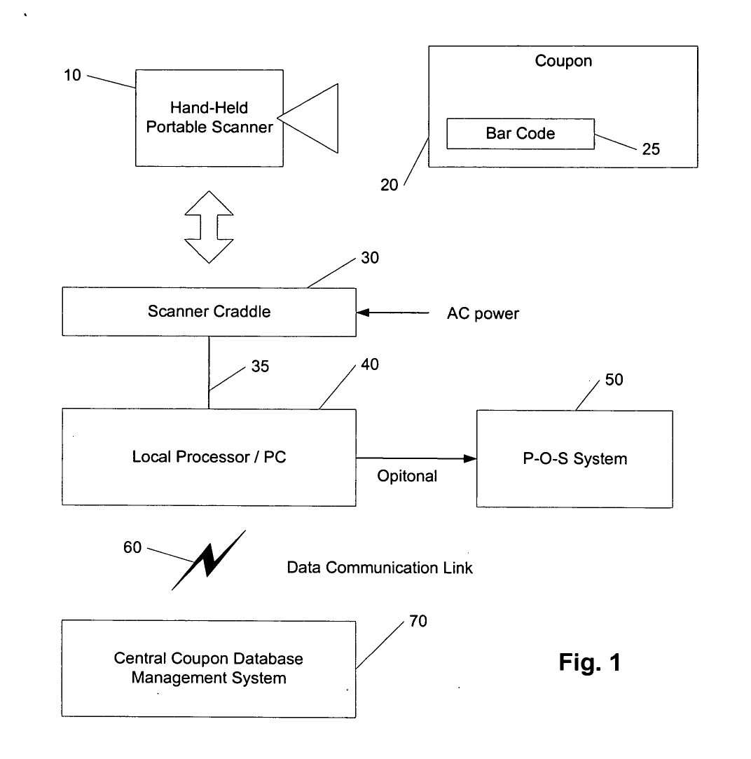

A block diagram of a preferred embodiment of the present invention is shown in FIG. 1. The present invention operates by providing the retail outlet with a portable, hand-held, battery operated barcode scanning wand 10. Wand 10 is completely portable and as such, may be used both within the retail outlet such as within the pizza restaurant, as well as outside the restaurant such as by a delivery driver who may be delivering a pizza to an office or residence. When a consumer wishes to redeem a coupon 20, the sales clerk is directed to scan the coupon using hand-held barcode scanner 10. Scanner 10 serves several important functions. Firstly, scanner 10 is able to detect a valid barcode 25 and capture the day, date, and in particular, the time of day that the scan has been made towards pinpointing exact the time that coupon 20 was redeemed, and in turn, when the associated purchase was made. Scanner 10 further captures the barcode data associated with barcode 25, which identifies a number of parameters such as the nature of the offer being redeemed, the media through which the offer was disseminated, and, in some cases, the actual intended recipient of the promotional offer/coupon if it was disseminated in a targeted manner, such as by direct mail to a consumer.

It is envisioned that coupons used with the present system include barcodes which have encoded therein various of these data points. Additionally, a number of different bar code formats may be used. For example, a coupon which is disseminated in a Sunday newspaper would not necessarily include the intended recipient inasmuch as the same coupon appears in each copy of the printed newspaper, but certainly would include an identification of the media, namely the Sunday newspaper, in which the offer appeared.

The hand-held scanner functions in conjunction with a cradle 30 to which it is returned on a periodic basis. Cradle 30 serves to provide a data port/data link 35 through which the data stored temporarily within the internal memory of scanner 10 may be downloaded from scanner 10 into an associated computerized processor 40. Cradle 30 may also function to recharge the batteries within hand-held scanner 10. Processor 40 may be a dedicated processor associated with the scanner or may comprise a generic personal computer running standard and/or customized software. The data captured by Scanner 10 is thereafter uploaded to any one of a number of different computerized systems.

Although, in the embodiment illustrated in FIG. 1, a scanner cradle is employed to transfer coupon redemption data, including information scanned from the coupon's bar code as well as the associated timestamp information, other methods of transferring the coupon redemption data are also contemplated. For example, a wireless link, such as WiFi or Bluetooth, may also be employed. When a wireless link is employed, the scanner and local processor are capable of sensing when they are in close enough proximity to each other to establish a reliable wireless data link, and then automatically transferring the coupon redemption data from the scanner to the local processor.

For example, the data may be uploaded directly to a computerized coupon database management system 70, or may be uploaded to another system. The unique feature is, of course, that the data is being captured in real-time, and that the data may be uploaded as frequently as deemed appropriate given the particular retail outlet. For example, a plurality of scanners 10 may be returned to their respective cradles 30 and the redemption data uploaded each evening. In other situations, it may be advisable to capture the data from a plurality of scanners 10 more frequently during the day. In either case, the data is made available in virtual real-time without the need of incurring the lengthy delays traditional incurred in obtaining this important information.

In addition to being used within the retail outlet, the portable hand-held scanner 10 may be used by delivery drivers at remote locations. For example, a delivery driver delivering a pizza to a residence may use scanner 10 to process a coupon at the consumer's home. Upon delivering the pizza, the delivery driver scans the coupon 20 presented by the consumer. Scanner 10 time stamps the date, day and time of redemption within the scanner's memory and in association with the data obtained directly from bar code 25, thereby confirming the exact day and time that coupon 20 was redeemed and, it may be assumed, the approximate time when the pizza was consumed. Upon returning to the retail store, the driver simply returns scanner 10 to its associated cradle 30 whereupon the redemption data is be extracted and uploaded to coupon management database system 70.

The present invention contemplates various means for communicating the coupon redemption data to the centralized coupon database management system, via various forms of a data communications link 60. For example, the processor or personal computer 40 may communicate via the internet with a dedicated website to upload data. Alternatively, a more conventional telephone/modem arrangement may be provided whereby a direct connection is made to a central system. It is also contemplated by the present invention to utilize cellular and/or wireless handsets or transceivers to communicate the data to central database management system 70.

Once the redemption data is received by central coupon database management system 70, the present management system is able to use this data in a unique and highly effective manner. For example, computerized coupon database management system 70 may be used to dynamically generate new coupons 20 based upon the redemption statistics. For example, if the redemption data shows that a particular media outlet, such as a Sunday newspaper, generates a much higher redemption percentage than newspapers published on any other day, the system can regenerate coupons targeted for that most popular day, if that is intended. Alternatively, the system may be used to generate coupons 20 which are targeted to media outlets or geographical regions that are deemed to be under-performing.

In the context of a highly competitive business, such as national pizza chains, any and every opportunity for increasing and managing the business is critical. A four week delay in obtaining coupon redemption data is typically unacceptable. Being able to monitor the effectiveness of a coupon campaign and respond quickly to detected trends and/or problems is essential.

The present invention accordingly provides a low-cost and relatively unobtrusive method for capturing coupon redemption data which provides for the rapid response to market trends. For example, the present system, being extremely affordable, permits its widespread use. Each order terminal, or point-of-sale system 50 and each delivery driver can be provided with a scanner 10 to capture coupon redemption data. Centralized coupon database management system 70 permits a single corporate manager to control, configure, monitor and manage all coupon-related activities for a national pizza chain. The system provides for integrated control of both the configuration, dissemination and redemption of a coupon based marketing program. Visual images of coupons can be stored in database management system 70 for later recall and modification. Statistical data can be linked to the images for ready access and ease of use. The coupon database can dynamically generate new coupon offers based upon the data captured by the scanners at the point-of-sale.

The ability to offer ease of use in coupon redemption afforded by the present invention provides a critical edge In the context of home delivery of pizza. For example, if the redemption data shows that home deliveries are very popular during lunchtime in a particular area, the system can generate further coupons targeting that same area, or may otherwise target areas that appear to be under-performing. The restaurant issuing coupons from which the redemption data is derived is able to accurately and timely track its advertisement investment and maximize its business performance.

In a further embodiment of the present invention it is envisioned that the present system could be used with handheld scanners 10 that include and/or have access to a global positioning system satellite data receiver whereby the longitude and latitude coordinates of the scanner may be captured when scanner 10 scans each coupon bar code. This embodiment is particularly useful in mobile applications, such as pizza delivery promotions, whereby the exact location of the place of redemption can be determined together with a time and date. In the context of a coupon printed in a full run of a regional newspaper, the centralized coupon database management system 70 may be used to determine where within the overall circulation region coupons were redeemed translating into the locations where pizzas were delivered.

The foregoing description and drawings merely explain and illustrate the invention, and the invention is not limited thereto, except insofar as the appended claims are so limited as those skilled in the art having the present disclosure before them will be able to make modifications and variations therein without departing from the scope of the invention.

1. A method for redeeming coupons having encoded information and for processing coupon redemption data, comprising:
scanning a coupon's encoded information;
recording timestamp information in association with the encoded information, the timestamp information specifying the date and approximate time when the coupon was scanned;
transferring the encoded information and the associated timestamp information to a local processor; and
automatically uploading the encoded information and the associated timestamp information from the local processor to a central coupon database management system in real-time via a data communication link.

2. The invention according to claim 1, further comprising the step of gathering coupon redemption statistical information from among a plurality of redeemed coupons.

3. The invention according to claim 2, further comprising the step of analyzing the coupon redemption statistical information toward identifying patterns in redemption frequencies, in association with a plurality of media outlets by which associated coupons were distributed to consumers.

4. The invention according to claim 3, further comprising the step of dynamically generating additional coupons based upon the analyzed coupon redemption statistical information and targeted to one or more of the plurality of media outlets.

5. The invention according to claim 4, wherein at least one of the plurality of media outlets is a newspaper.

6. The invention according to claim 2, further comprising the step of analyzing the coupon redemption statistical information to determine an overall effectiveness of a marketing campaign by which the coupons are distributed to consumers.

7. The invention according to claim 1, wherein the encoded information of the coupon comprises bar coded information, and the step of scanning a coupon's encoded information comprises scanning the coupon's bar coded information using a bar code scanner.

8. The invention according to claim 7, wherein the bar code scanner comprises a hand-held bar code scanner.

9. The invention according to claim 8, wherein the hand-held bar code scanner comprises a portable hand-held bar code scanner.

10. The invention according to claim 7, wherein the local processor includes a local data link for accepting data from the bar code scanner.

11. The invention according to claim 10, wherein the local data link comprises a scanner cradle operably coupled to the local processor, and the step of transferring the encoded information and associated timestamp information comprises placing the scanner into the scanner cradle to automatically transfer the encoded information and associated timestamp information.

12. The invention according to claim 10, wherein the local data link comprises a wireless data link, and the step of transferring the encoded information and associated timestamp information comprises placing the scanner in sufficient proximity to the local processor to establish a reliable wireless data connection therebetween to automatically transfer the encoded information and associated timestamp information.

13. The invention according to claim 1, wherein the data link comprises an internet connection operably coupling the local processor and the central coupon database management system.

14. The invention according to claim 1, wherein the data link comprises a modem and conventional voice telephone connection.

15. The invention according to claim 1, wherein a point-of-sale system is operably coupled to the local processor.

16. A coupon redemption and processing system for use in association with coupons having encoded information, comprising:
a scanner capable of scanning the coupon's encoded information and recording timestamp information relative to when the coupon was scanned;
a local processor having a local data link connectable to the scanner and capable of accepting and temporarily storing the coupon's encoded information and associated timestamp information when a local data connection is established between the local processor and the scanner;
a central coupon database management system, remotely located relative to the local processor and capable of gathering statistical information from among a plurality of redeemed coupons; and
a data communication link operably coupled to the local processor and the central coupon database management system for transferring the coupon's encoded information and associated timestamp information in real-time from the local processor to the central computer database management system.

17. The invention according to claim 16, wherein the coupon redemption and processing system further includes a point-of-sale system operably coupled to the local processor.
